(19) United States
(12) Patent Application Publication
(10) Pub. No.: US 2023/0292732 A1
(43) Pub. Date: Sep. 21, 2023

(54) GROUND MARKING CONTROL FOR GROUND TREATMENT VEHICLE AND METHOD OF OPERATING SAME

(71) Applicant: EXMARK MANUFACTURING COMPANY INCORPORATED, Beatrice, NE (US)

(72) Inventors: Jeffrey J. Moore, Beatrice, NE (US); Kent E. Harlan, Beatrice, NE (US); Kyler J. Macy, Minneapolis, KS (US)

(21) Appl. No.: 17/700,095

(22) Filed: Mar. 21, 2022

(51) Int. Cl. A01M 7/00; A01C 15/04; A01M 9/00

(52) U.S. Cl. CPC A01M 7/0042; A01C 15/04; A01M 7/0089; A01M 9/0092

(57) ABSTRACT

A ground treatment vehicle, and system thereof, having a treating reservoir configured to hold a ground treating material and a treating material delivery system configured to deliver the treating material to a ground surface. The vehicle also having a marker reservoir for holding a marking fluid and a marker system configured to deliver the marking fluid to the ground surface. The vehicle also including a treating material control having a first treating setting in which treating material delivery system is enabled and a second treating setting in which treating material delivery system is disabled. The vehicle also including a marker fluid control having a first marker setting in which the marker system is enabled, a second marker setting in which the marker system disabled, and a third marker setting in which the marker system matches the treating material delivery system.

Embodiments of the present disclosure generally concern ground treatment (e.g., spreading and/or spraying) vehicles and, more particularly, to ground marking controls and methods for use with the same.

### BACKGROUND

Ground treatment vehicles are well known for applying various chemicals (including liquids and/or granular material) to a ground surface. For example, ground spraying vehicles are known for delivering chemicals such as fertilizers, herbicides, and pesticides to turf surfaces to promote and maintain turf health. Such vehicles may include a series of nozzles situated across a transverse width of the vehicle to deliver liquid chemicals. In addition or alternatively, the vehicle may include one or more broadcast spinners to disperse granular materials.

In operation, the vehicle may be driven over the turf surface in successive, back-and-forth generally parallel paths. As the applied chemicals are often invisible once applied, the operator of the vehicle may be unable to adequately discern the lateral extent to which the chemical was applied to the turf surface during the previous pass. If the boundaries of the previous pass are not discernible, the operator may inadvertently apply chemical to turf areas that were already treated during the previous pass (e.g., over treat), or alternatively miss a portion or “strip” of the turf surface between successive passes (e.g., under treat).

### SUMMARY

Embodiments described herein may provide a ground treatment vehicle including a chassis supported upon a ground surface by ground engaging members. The vehicle may also include a treating reservoir attached to the chassis and configured to hold a ground treating material, and a treating material delivery system configured to deliver the treating material from the treating reservoir to the ground surface. Further, the vehicle may include a marker reservoir for holding a marking fluid and a marker system configured to deliver the marking fluid from the marker reservoir to the ground surface. The vehicle may include a treating material control configured to control the treating material delivery system. The treating material control may include a first treatment setting in which the treating material delivery system is enabled so that the treating material is transferred to the ground surface. The treating material control may also include a second treatment setting in which the treating material delivery system is disabled. The vehicle may also include a marker fluid control configured to control flow of the marker fluid from the marker reservoir to a marker nozzle operatively attached to the chassis. The marker fluid control may include a first marker setting in which the marker system is enabled to deliver the marking fluid to the ground surface and a second marker setting in which the marker system is disabled. The marker fluid control may also include a third marker setting in which the marker system is enabled when the treating material control is in the first treatment setting, and disabled when the treating material control is in the second treatment setting.

Other embodiments described herein may provide a system for controlling a visual marker system configured to identify a lateral treatment path boundary resulting from application of a ground treating material by a ground treatment vehicle. The system may include a treating reservoir attached to a chassis of the vehicle and configured to hold a volume of ground treating material, and a treating material delivery circuit configured to selectively deliver the treating material from the treating reservoir to a ground surface. The system may also include a marker reservoir attached to the chassis for holding a volume of marking fluid and a marker circuit configured to deliver the marking fluid from the marker reservoir to the ground surface. The system may include a treating material control configured to control the treating material delivery circuit. The treating material control may include a first treatment setting in which the treating material delivery circuit is enabled so that the treating material is transferred to the ground surface. The treating material control may also include a second treatment setting in which the treating material delivery circuit is disabled. The system may also include a marker fluid control configured to control flow of the marker fluid from the marker reservoir to a marker nozzle operatively attached to the chassis. The marker fluid control may include a first marker setting in which the marker circuit is enabled to deliver the marking fluid to the ground surface and a second marker setting in which the marker circuit is disabled. The marker fluid control may also include a third marker setting in which the marker circuit is enabled when the treating material control is in the first treatment setting, and disabled when the treating material control is in the second treatment setting.

Yet other embodiments described herein may provide a system for controlling a visual marker system configured to identify a lateral treatment path boundary resulting from application of a ground treating material by a ground treatment vehicle. The system may include a treating reservoir attached to a chassis of the vehicle and configured to hold a volume of ground treating material, and a treating material delivery circuit configured to selectively deliver the treating material from the treating reservoir to a ground surface. The system may also include a marker reservoir attached to the chassis for holding a volume of marking fluid and a marker circuit configured to deliver the marking fluid from the marker reservoir to the ground surface. The system may include a treating material control configured to control the treating material delivery circuit. The treating material control may include a first treatment setting in which the treating material delivery circuit is enabled so that the treating material is transferred to the ground surface and a second treatment setting in which the treating material delivery circuit is disabled. The system may also include a marker fluid control configured to control flow of the marker fluid from the marker reservoir to a marker nozzle operatively attached to the chassis. The marker fluid control may include an independent marker configuration in which the marker circuit is enabled to deliver the marking fluid to the ground surface or disabled from delivering the marking fluid regardless of the treatment setting of the treating material control. The marker fluid control may also include a dependent marker configuration in which the marker circuit is enabled when the treating material control is in the first treatment setting and disabled when the treating material control is in the second treatment setting.

The above summary is not intended to describe each embodiment or every implementation. Rather, a more complete understanding of illustrative embodiments will become apparent and appreciated by reference to the following Detailed Description of Exemplary Embodiments and claims in view of the accompanying figures of the drawing.

### BRIEF DESCRIPTION OF THE VIEWS OF THE DRAWING

Exemplary embodiments will be further described with reference to the figures of the drawing, wherein:

FIG. 1 is a front perspective view of a ground treatment vehicle having a ground marking control in accordance with embodiments of the present disclosure;

FIG. 2 is a rear perspective view of the ground treatment vehicle of FIG. 1;

FIG. 3 is an expanded view of an operator platform of the ground treatment vehicle of FIG. 2;

FIG. 4 is an expanded view of an operator control panel of the ground treatment vehicle of FIG. 2;

FIG. 5 is an isolated view of a marker reservoir and a marker system of the ground treatment vehicle of FIG. 1;

FIG. 6 is an isolated view of a treating reservoir and a treating material delivery system of the ground vehicle of FIG. 1; and

FIG. 7 is an expanded view of a portion of the marker system of FIG. 5 and the treating material delivery system of FIG. 6 operatively coupled to a ground treatment vehicle.

The figures are rendered primarily for clarity and, as a result, are not necessarily drawn to scale. Moreover, various structure/components, including but not limited to fasteners, electrical components (wiring, cables, etc.), and the like, may be shown diagrammatically or removed from some or all of the views to better illustrate aspects of the depicted embodiments, or where inclusion of such structure/components is not necessary to an understanding of the various exemplary embodiments described herein. The lack of illustration/description of such structure/components in a particular figure is, however, not to be interpreted as limiting the scope of the various embodiments in any way.

### DETAILED DESCRIPTION OF EXEMPLARY EMBODIMENTS

In the following detailed description of illustrative embodiments, reference is made to the accompanying figures of the drawing which form a part hereof. It is to be understood that other embodiments, which may not be described and/or illustrated herein, are certainly contemplated.

All headings provided herein are for the convenience of the reader and should not be used to limit the meaning of any text that follows the heading, unless so specified. Moreover, unless otherwise indicated, all numbers expressing quantities, and all terms expressing direction/orientation (e.g., vertical, horizontal, parallel, perpendicular, etc.) in the specification and claims are to be understood as being modified in all instances by the term “about.” The term “and/or” (if used) means one or all of the listed elements or a combination of any two or more of the listed elements. The term “i.e.” is used as an abbreviation for the Latin phrase id est and means “that is.” The term “e.g.” is used as an abbreviation for the Latin phrase exempli gratia and means “for example.”

Embodiments of the present disclosure are directed to a ground treatment vehicle including a marker fluid control that may be adjusted to be dependent on a treating material control. For example, in one or more embodiments, the marker fluid control may be tied to the treating material control such that a marker system (corresponding to the marker fluid control) is enabled when a treating material system (corresponding to the treating material control) is enabled and the marker system is disabled when the treating material system is disabled. In other words, when the treating material system is enabled to dispense ground treating material, the marker system is enabled to process the marking fluid (e.g., so that the marking fluid can be dispensed). Therefore, foam formed from the marking fluid may assist in identifying which portions of the ground surface have treating material applied thereto. Specifically, the marker fluid control may include a setting in which the marker fluid control matches the treating material control. In addition to the marker fluid control having a setting to match the treating material control, in one or more embodiments, the marker fluid control may also include settings that enable and disable the marker system (e.g., independent from the treating material system).

In one or more embodiments, the setting for the marker fluid control that matches treating material control may be described as a dependent marker configuration. Further, the settings for the marker fluid control that enable and disable the marker system (independent from the treating material system) may be described as an independent marker configuration. Additionally, the independent marker configuration may include an on position in which the marker system is enabled and an off position in which the marker system is disabled.

By allowing the marker fluid control to be tied to the treating material control, the marker controls may be simplified. In other words, an operator may not need to actively turn the marker system on and off (e.g., because the marker system toggles with the treating material system). As such, the operator may be able to focus on driving the vehicle and increase productivity.

Prior ground treatment vehicles have two separate controls that independently enable/disable the marker system and the treating material system. Therefore, the operator may need to monitor and use two separate controls (e.g., instead of, effectively, using one control for both). Specifically, in the prior vehicle, each time the operator enables the treating material system, the operator may also need to enable the marker system (e.g., otherwise the operator could not track movement using the marking fluid) and each time the operator disables the treating material system, the operator may also need to disable the marker system (e.g., otherwise the operator may be tracking movement where there is no ground treating material).

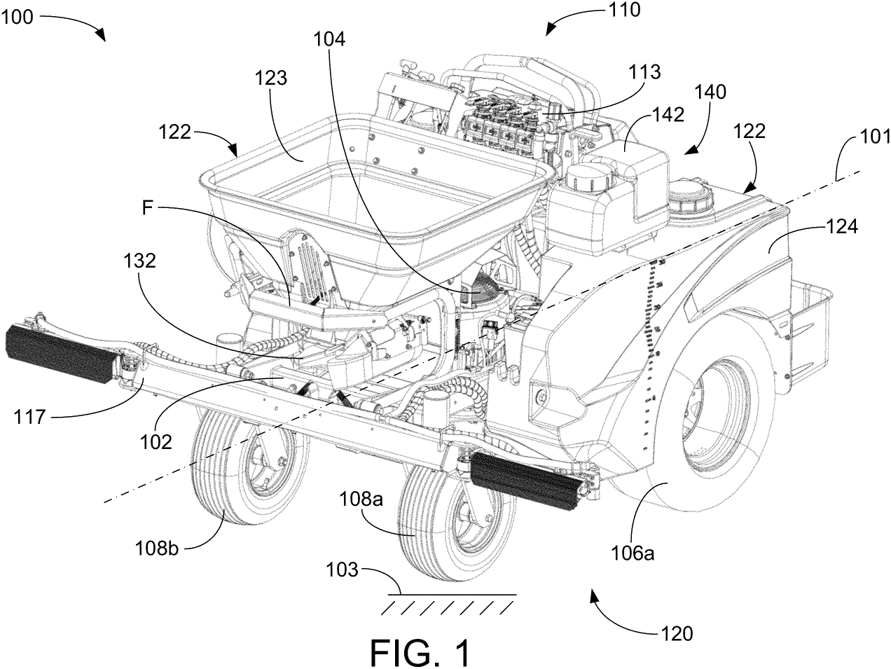

With reference to the figures of the drawing, wherein like reference numerals designate like parts and assemblies throughout the several views, FIGS. 1-7 illustrate a ground treatment vehicle 100, in accordance with one embodiment of the present disclosure, including a marker fluid control (e.g., controlling a marker system) that may be interrelated to a treating material control (e.g., controlling a treating material delivery system).

It is noted that the terms “have,” “include,” “comprise,” and variations thereof, do not have a limiting meaning, and are used in their open-ended sense to generally mean “including, but not limited to,” where the terms appear in the accompanying description and claims. Further, “a,” “an,” “the,” “at least one,” and “one or more” are used interchangeably herein. Moreover, relative terms such as “left,” “right,” “front,” “fore,” “forward,” “rear,” “aft,” “rearward,” “top,” “bottom,” “side,” “upper,” “lower,” “above,” “below,” “horizontal,” “vertical,” and the like may be used herein and, if so, are from the perspective shown in the particular figure, or while the vehicle 100 is in an operating configuration (e.g., while the machine 100 is positioned such that wheels 106 and 108 rest upon a generally horizontal ground surface 103 as shown in FIG. 1). These terms are used only to simplify the description, however, and not to limit the interpretation of any embodiment described. In a similar manner, term such as “first” and “second” may be used herein to describe various elements. However, such terms are used for nothing more than to distinguish elements from one another.

Further, it is understood that the description of any particular element as being connected or coupled to another element can be directly connected or coupled, or indirectly coupled via intervening elements.

Still further, the suffixes “a” and “b” may be used throughout this description to denote various left- and right- side parts/features, respectively. However, in most pertinent respects, the parts/features denoted with “a” and “b” suffixes are substantially identical to, or mirror images of, one another. It is understood that, unless otherwise noted, the description of an individual part/feature (e.g., part/feature identified with an “a” suffix) also applies to the opposing part/feature (e.g., part/feature identified with a “b” suffix). Similarly, the description of a part/feature identified with no suffix may apply, unless noted otherwise, to both the corresponding left and right part/feature.

The ground treatment vehicle 100 described herein may include any suitable vehicle having a material application apparatus. Further, the vehicle 100 described herein may be configured as a powered, ride-on vehicle that is self-propelled and adapted to provide a material application to a ground surface. In one or more embodiments, the material application apparatus may include one or both of a granular material (e.g., turf fertilizer, seed, ice control materials, etc.) broadcast spreader and a liquid (e.g., fertilizer, ice control materials, etc.) sprayer (e.g., to form a “spreader/sprayer” vehicle). While the material application apparatus may be removably attached to a general purpose utility vehicle, the vehicle illustrated in the figures is a dedicated spreader/sprayer.

While the general construction of the vehicle 100 is not necessarily central to an understanding of exemplary embodiments (e.g., other vehicle or machine configurations are certainly contemplated), the general construction of the vehicle 100 is briefly described below.

FIG. 1 illustrates the vehicle including a frame or chassis 102 having a front end F and a rear end R (and a longitudinal axis 101 extending between the front and rear ends). As used herein, a transverse axis or plane refers to an axis or plane that is normal to the longitudinal axis 101 (e.g., upon which lateral positions may be defined). The chassis 102 may support a power source or prime mover 104 (e.g., internal combustion engine or electric motor) configured to power the vehicle 100. A pair of transversely opposing, ground engaging members, e.g., first and second (left and right) rear drive wheels 106a and 106b, may be coupled to opposite (left and right) rear sides of the chassis 102 to support the vehicle 100 upon, and propel the vehicle 100 relative to, the ground surface 103. Each drive wheel 106 may be powered by its own hydraulic motor that receives power from, at least in one embodiment, its own hydrostatic pump. Other drive systems, e.g., gear or pulley driven systems, may also be utilized by the vehicle 100.

Operator controls, as further described below, permit independent control of the speed and direction of each drive wheel 106, allowing operator control of vehicle 100 speed and direction. The operator may control the vehicle from a sitting position or from a walking or riding (e.g., standing) position generally behind the vehicle 100. A pair of front ground-engaging members (e.g., left and right wheels 108a, 108b), which may be connected to forwardly extending frame rails (of the chassis 102), may support the front of the vehicle 100 in rolling engagement with the ground surface 103.

Although the illustrated vehicle 100 has the drive wheels 106 in the rear and undriven or caster wheels 108 in front, this configuration is not limiting. For example, other embodiments may reverse the location of the wheels, e.g., drive wheels in front and driven or undriven wheels in back. Moreover, other configurations may use different wheel configurations altogether, e.g., a tri-wheel configuration, a vehicle having conventionally-steered wheels, independently-driven wheels, etc. These and other embodiments are certainly possible without departing from the scope of the present disclosure. Moreover, while illustrated herein as wheels, other ground-engaging members (e.g., tracks, skids, etc.) are also contemplated.

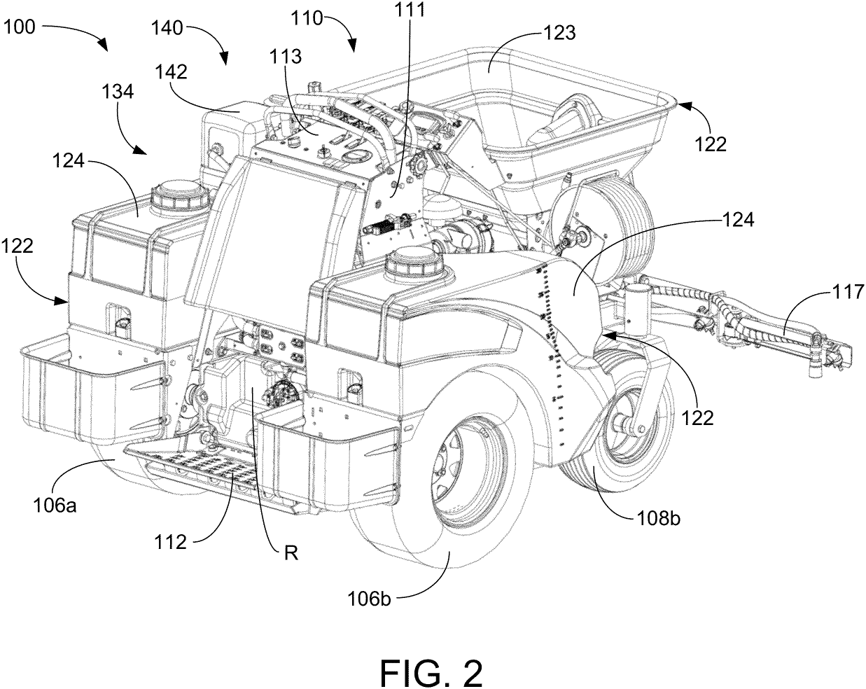

The vehicle 100 may further include an operator control system 110. In the illustrated embodiment, the control system 110 may include operator controls that are mounted to upwardly extending portions of the chassis referred to herein as a control tower 111 (e.g., as shown in FIG. 2). The control tower 111 may be located at or near the rear end R of the vehicle 100. Situated near the top of the control tower 111 is an operator control panel 113 that positions vehicle controls within comfortable reach of an operator who may be standing either behind the vehicle or upon a platform. The control system 110 may include control levers configured to move the vehicle 100 forward and rearward. The control system 110 may also include a treating material control and a marker fluid control, as further described herein.

Further, the illustrative vehicle 100 may include an operator support configured to support an operator standing behind the vehicle 100 such that the operator is positioned relative to the control system 110 and moves along with the vehicle 100. The operator support may include a standing platform 112 attached to the chassis 102 at or near the rear end R, as shown in FIG. 2. The standing platform 112 may be configured to support the standing operator. Specifically, the operator support (e.g., including the standing platform 112) may be located aft of the control tower 111.

A treating material delivery system 120 or treating material delivery circuit may be operatively coupled to the chassis 102 of the vehicle 100 and configured to dispense ground treating material to the ground surface 103. Further, the vehicle 100 may include a treating reservoir 122 attached to the chassis 102 and configured to hold a ground treating material. The treating material delivery system 120 may be configured to deliver the treating material from the treating reservoir 122 to the ground surface 103.

The treating material delivery system 120 may take the form of one or both of a liquid delivery system and a granular delivery system. For example, as shown in FIG. 1, the treating reservoir 122 may include a granular reservoir 123 or hopper attached proximate the front of the vehicle 100. Although, the granular reservoir 123 may be positioned at any suitable location relative to the chassis 102. The ground treating material may include granular materials that are transferred into (e.g., by pouring into an opening at the top of the granular reservoir 123) and stored in the granular reservoir 123. The granular materials may include, e.g., fertilizer, seed, ice control materials, weed control, pesticide, herbicide, etc.

The granular materials may be dispensed from the granular reservoir 123 (e.g., proximate a bottom of the granular reservoir 123) into a broadcast spinner 132 (e.g., as shown in FIG. 1). The broadcast spinner 132 may be configured to rotate to deliver or “throw” the granular treating material from the granular reservoir 123 to the ground surface 103. The broadcast spinner 132 may be operatively powered by the engine 104 via, e.g., spindles and a drive system. In other words, during operation, power may be selectively delivered to the broadcast spinner 132, whereby the broadcast spinner 132 rotates at a sufficient speed to disperse treating material.

The rotation of the broadcast spinner 132 may assist in dispersing the granular material to a distance away from the broadcast spinner 132. The distance for which the granular material is spread may be defined as a treatment width (e.g., measured in the transverse or lateral direction). In other words, the treatment width may determine the distance between parallel paths (e.g., a lateral treatment path boundary) traversed by the vehicle 100 to efficiently cover the ground surface 103 with treating material (e.g., without under treating or over treating).

Also, for example, the treating reservoir 122 may include a liquid reservoir 124. As shown in FIG. 2, two liquid reservoirs 124 are attached to the chassis 102 on either side of the vehicle 100. Specifically, the two liquid reservoirs 124 are located above (and contour around) the rear wheels 106. Although, the liquid reservoir 124 may be positioned at any suitable location relative to the chassis 102. Further, the vehicle 100 may have any suitable number of liquid reservoirs 124 (e.g., one, two, three, four, etc.). The ground treating material may include a liquid material that is transferred into and stored in the liquid reservoir 124. The liquid material may include, e.g., fertilizer, ice control liquid, weed control, pesticide, herbicide, etc.

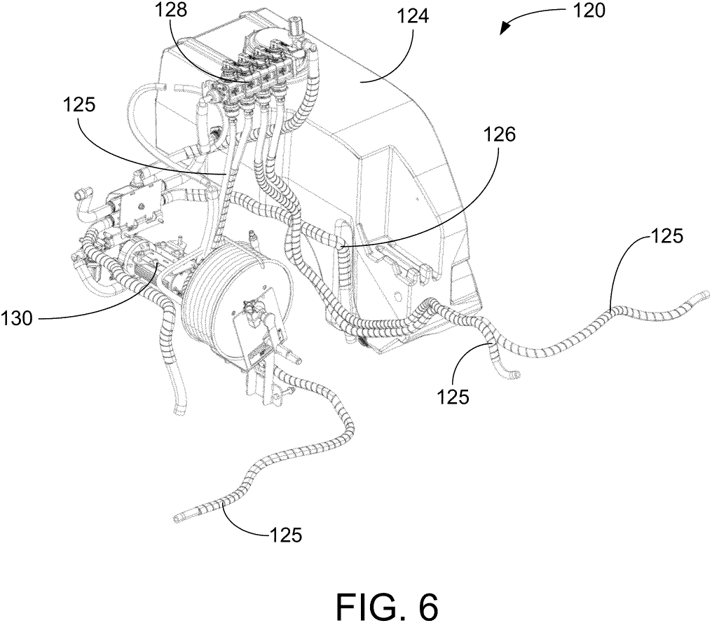

The treating material delivery system 120 including liquid components is shown isolated from the remainder of the vehicle in FIG. 6. For example, one liquid reservoir 124 is illustrated with conduits or tubes connected thereto to transfer the liquid treating material. Specifically, the treating material delivery system 120 may include liquid transfer conduits 126 operatively coupled to the liquid reservoir 124 such that liquid material within the liquid reservoir 124 may be delivered from the liquid reservoir 124.

The liquid transfer conduits 126 may also be operatively coupled to a treatment manifold 128 (e.g., at the opposite end from the coupling with the liquid reservoir 124). The treatment manifold 128 may include one or more valves corresponding to one or more liquid dispense conduits 125. The one or more valves may be configured to control the flow through the corresponding one or more liquid dispense conduits 125. The one or more liquid dispense conduits 125 may be operatively coupled to the treatment manifold 128 and extend therefrom to a location at which the liquid material may be delivered to the ground surface 103. Further, the treating material delivery system 120 may include a treatment pump 130 configured to deliver the liquid material from the liquid reservoir 124 (e.g., via the liquid transfer conduits 126), and through the liquid dispense conduits 125, to the ground surface 103.

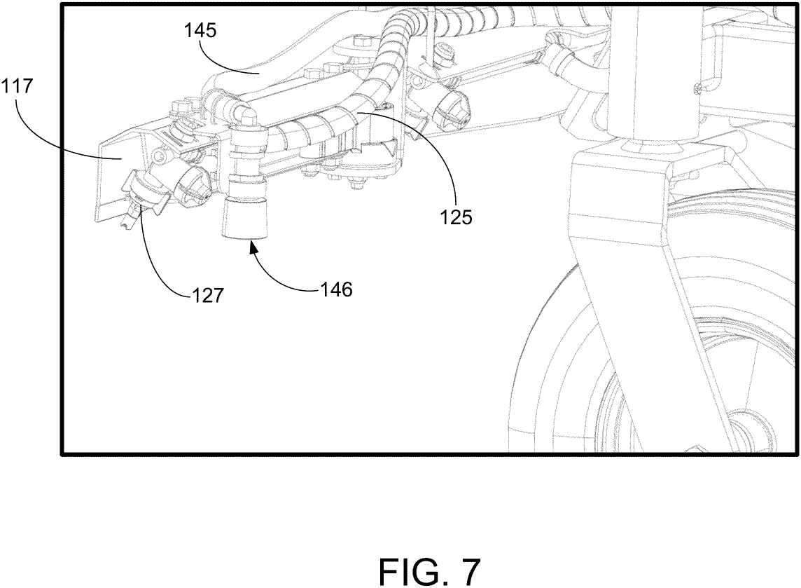

The treating material delivery system 120 may include any suitable number of liquid dispense conduits 125. For example, as shown in FIG. 6, the treating material delivery system 120 includes four liquid dispense conduits 125 extending to various locations relative to the vehicle (not shown in FIG. 6, but the front of the vehicle would be located towards the bottom right). In other embodiments, the treating material delivery system 120 may include, for example, one, two, three, four, five, etc. liquid dispense conduits 125. As shown in FIG. 6, the liquid dispense conduits 125 extend to locations that are proximate the front-right, front-center, and front-left relative of the vehicle 100. Further, as shown in FIG. 7, the end of the conduit 125 may include a treatment nozzle 127 configured to spray the liquid material on the ground surface 103. In one or more embodiments (e.g., as shown in FIG. 6), the treating material delivery system 120 may include a liquid dispense conduit 125 connected to a hose that may be manually controlled by an operator to deliver liquid material to a specific location at the direction of the operator.

The liquid dispense conduits 125 may be connected to a portion of the vehicle 100 proximate the end of the conduit 125 that dispenses the liquid material. For example, as shown in FIG. 7, the liquid dispense conduit 125 may be coupled to an adjustable bar 117 or boom located at the front of the vehicle 100 and extending in a transverse or lateral direction (e.g., also shown in FIG. 1). The adjustable bar 117 may be configurable in various positions or orientations (e.g., by manual or remote control) to modify the location from which the liquid material is sprayed by the treatment nozzles 127. The position of the liquid dispense conduits 125 relative to the vehicle 100 and the treatment nozzles 127 attached thereto may control the distance that the liquid material is sprayed. The distance for which the liquid material is sprayed may be defined as a treatment width (e.g., measured in the transverse or lateral direction). In other words, the treatment width may determine the distance between parallel paths (e.g., a lateral treatment path boundary) traversed by the vehicle 100 to efficiently cover the ground surface 103 with treating material (e.g., without under treating or over treating).

The ground treating material may be controlled to be delivered in any suitable way. For example, the vehicle 100 may include a treating material control 134 configured to control the treating material delivery system 120. The treating material control 134 may be located in any suitable position in which the operator may easily access the treating material control 134 while operating the vehicle 100. For example, the treating material control 134 may be located on or proximate the control tower 111 at which the operator is positioned.

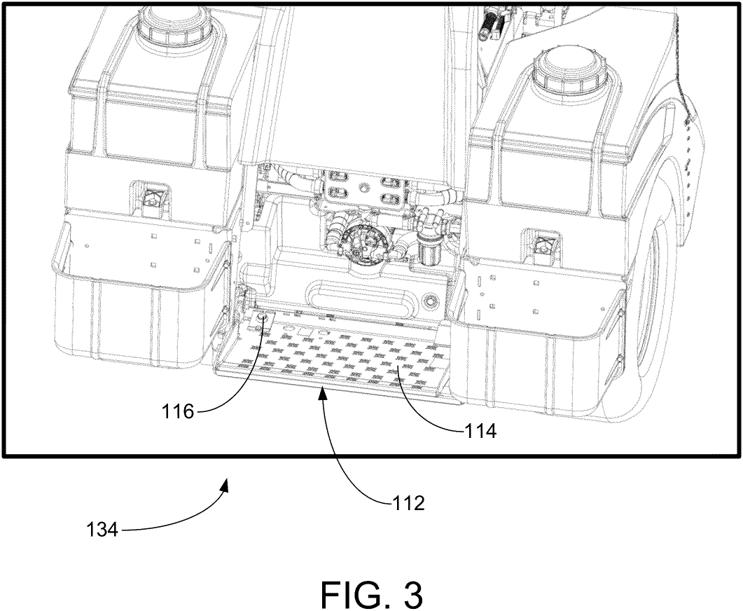

Specifically, the treating material control 134 may include a foot-actuated switch 116 located upon the standing operator platform 112 attached to the chassis 102 as shown in FIG. 3. The foot-actuated switch 116 may be positioned on an upper surface 114 of the standing platform 112 such that the operator may actuate the foot-actuated switch 116 with, e.g., a front portion of the foot (e.g., left or right). The foot-actuated switch 116 may be configured such that the treating material delivery system 120 is only enabled when the foot-actuated switch 116 is actuated. In other words, a default position of the foot-actuated switch 116 configures the treating material delivery system 120 to be disabled and can only be enabled when the operator applies constant pressure on the foot-actuated switch 116.

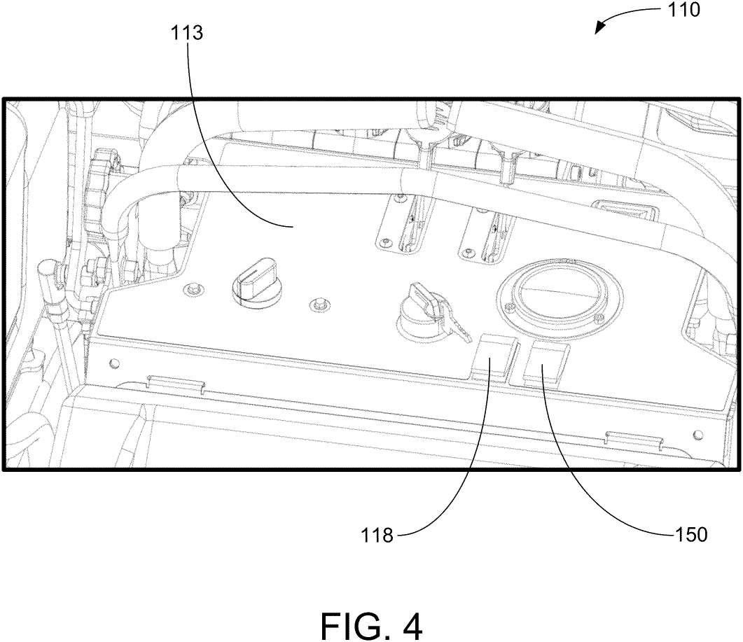

Also, the treating material control 134 may include a hand-operated switch 118 located on an operator control panel 113 attached to the chassis 102 (e.g., located on the control tower 111) as shown in FIG. 4. The hand-operated switch 118 may be positioned on the operator control panel 113 of the control tower 111 such that the operator may manipulate the hand-operated switch 118 while operating the vehicle 100 (e.g., at any suitable location on the operator control panel 113). The hand-operated switch 118 may be configured as a two-position switch such that the treating material delivery system 120 may be enabled in one position and disabled in the other position. In other words, the operator may enable or disable the treating material delivery system 120 without applying a constant force to the hand-operated switch 118 (e.g., the hand-operated switch 118 stays in whichever position until changed by the operator).

Either of the foot-actuated switch 116 and the hand-operated switch 118 may be used to enable the treating material delivery system 120. In other words, the operator may use one or both of the treating material controls 134 to control the treating material delivery system 120 (e.g., whichever is preferable for a given application). For example, if the operator is selectively treating a portion of the ground surface, the operator may use the foot-actuated switch 116 to selectively enable the treating material delivery system 120. Also, for example, if the operator is continuously treating a portion of the ground surface, the operator may use the hand-operated switch 118 to set the treating material delivery system 120 to be enabled.

Regardless of how the treating material control 134 is physically configured or operated, the treating material control 134 may include two settings. For example, the treating material control 134 may include a first treatment setting in which the treating material delivery system 120 is enabled so that the treating material is transferred to the ground surface 103, and a second treatment setting in which the treating material delivery system 120 is disabled.

A marker system 140 or marker circuit may also be operatively coupled to the chassis 102 of the vehicle 100 and configured to identify the lateral treatment path boundary resulting from the application of a ground treating material by the treating material delivery system 120. In other words, the marker system 140 may act as a visual marker system for the operator to track which portions of the ground surface 103 have been treated. Further, the vehicle 100 may include a marker reservoir 142 (e.g., as shown in FIGS. 1 and 2) attached to the chassis 102 and configured to hold a volume of marking fluid. The marker system 140 may be configured to deliver the marking fluid from the marker reservoir 142 to the ground surface 103. The marker reservoir 142 may be located relative to the chassis 102 in any suitable position. As shown in FIGS. 1 and 2, the marker reservoir 142 is located adjacent to the control tower 111 (e.g., providing easy access to fill the marker reservoir 142 with marking fluid).

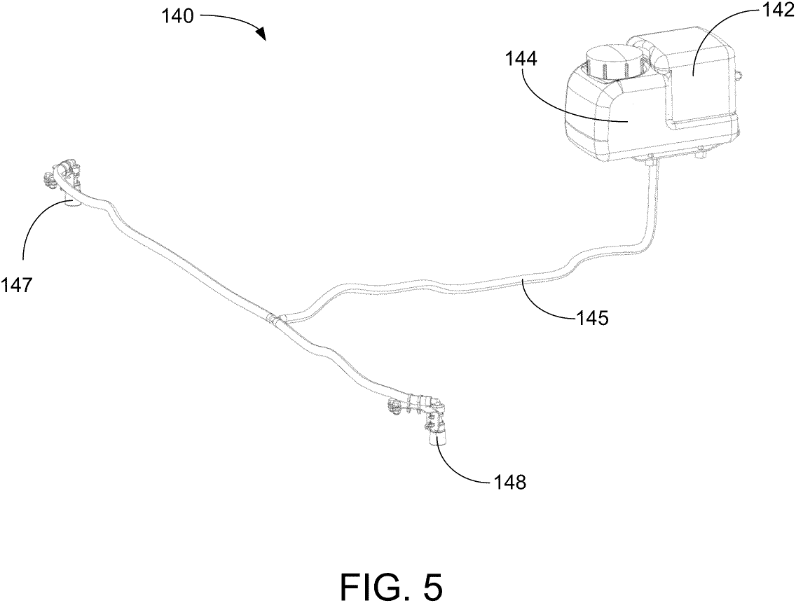

The marker system 140 is illustrated in FIG. 5, isolated from the remainder of the vehicle 100. The marker system 140 may include one or more marker conduits 145 operatively coupled to and extending from the marker reservoir 142. The one or more marker conduits 145 may direct the flow of the marking fluid from the marker reservoir 142 to an end of the one or more marker conduits 145 opposite the marker reservoir 142. Further, the marker system 140 may include a marker pump 144 configured to deliver the marking fluid from the marker reservoir 142, and through the one or more marker conduits, to the ground surface 103.

Additionally, the marker system 140 may include marker nozzles 146 (e.g., shown as first marker nozzle 147 and second marker nozzle 148 in FIG. 5) located at the end of the one or more marker conduits 145 opposite the marker reservoir 142 and configured to dispense and/or foam the marking fluid. The marking fluid may include any suitable material. For example, the marking fluid may include a foam concentrate, soap (e.g., dish soap) and water, etc. Specifically, the marking fluid may be any suitable material that includes a foaming agent such that foam is delivered to the ground surface 103 in such a way that is visible to the operator for a suitable amount of time.

The marker nozzles 146 may be positioned relative to the vehicle 100 such that the marker nozzles 146 align with the outer edge (e.g., on both lateral sides) of the treatment range of the treating material delivery system. Also, similar to the treatment nozzles 127, the marker nozzles 146 may be coupled to the adjustable bar 117 proximate the front of the vehicle 100 (e.g., as shown in FIG. 7). As such, the marker nozzles 146 may move along with the treatment nozzles 127 to identify the treatment boundary of the treating material delivery system.

As shown in FIG. 5 (illustrating the marker system 140 isolated from the remainder of the vehicle 100 but maintaining a similar orientation as FIG. 1), the marker system 140 may include a first marker nozzle 147 configured to disperse marking fluid at a first lateral position (e.g., a right side) relative to the chassis 102, and a second marker nozzle 148 configured to disperse marking fluid at a second lateral position (e.g., a left side) relative to the chassis 102. The first and second marker nozzles 147, 148 may operate in unison (e.g., simultaneously) or individually (e.g., based on a selection by the operator). The first and second lateral positions may define or identify a treating width of the vehicle 100. In other words, the marker nozzles 146 may be aligned with the treating material delivery system 120 (e.g., the treatment nozzles 127) such that the marker fluid dispersed on the ground surface 103 identifies the boundary at which treating material may be applied to the ground surface 103 (e.g., the treatment width).

The vehicle 100 may also include a marker fluid control 150 configured to control flow of the marker fluid from the marker reservoir 142 to a marker nozzle 146 operatively attached to the chassis 102. The marker fluid control 150 may be located in any suitable position in which the operator may easily access the marker fluid control 150 while operating the vehicle 100. For example, the marker fluid control 150 may be located on or proximate the control tower 111 at which the operator is positioned.

Specifically, the marker fluid control 150 may be located on an operator control panel 113 (e.g., in any suitable location) attached to the chassis 102 (e.g., located on the control tower 111) as shown in FIG. 4. The marker fluid control 150 may be positioned on the operator control panel 113 of the control tower 111 such that the operator may manipulate the marker fluid control 150 while operating the vehicle 100.

Further, the marker fluid control 150 may be configurable to depend on the treating material control 134. For example, in one or more embodiments, the marker fluid control 150 may include a dependent marker configuration in which the marker system 140 matches or replicates a status (e.g., enabled or disabled) of the treating material delivery system 120. Specifically, the dependent marker configuration may define that the marker system 140 is enabled when the treating material delivery system 120 is enabled (e.g., when the treating material control 134 is in the first treatment setting) and the marker system 140 is disabled when the treating material delivery system 120 is disabled (e.g., when the treating material control 134 is in the second treatment setting).

Further yet, the marker fluid control 150 may also be configurable to be independent from the treating material control 134. For example, in one or more embodiments, the marker fluid control 150 may include an independent marker configuration in which the marker system 140 is enabled (e.g., to deliver the marking fluid to the ground surface 103) or disabled (e.g., not delivering the marking fluid to the ground surface 103) regardless of the status (e.g., enabled or disabled) of the treating material delivery system 120 (e.g., regardless of whether the treating material control 134 is in the first treatment setting or second treatment setting).

When in the independent marker configuration, the marker fluid control 150 may be further configurable between an on position and an off position. For example, the marker system 140 may be enabled to deliver the marking fluid when in the on position (e.g., regardless of the setting of the treating material control 134) and the marker system 140 may be disabled from delivering the marking fluid when in the off position (e.g., regardless of the setting of the treating material control 134).

As such, the marker fluid control 150 may include three marker settings. For example, the marker fluid control 150 may include a first marker setting in which the marker system 140 is enabled to deliver the marking fluid to the ground surface 103 (e.g., irrespective of the treating material delivery system 120 status), a second marker setting in which the marker system 140 is disabled (e.g., irrespective of the treating material delivery system 120 status), and a third marker setting in which the marker system 140 is enabled when the treating material delivery system 120 is enabled (e.g., when the treating material control 134 is in the first treatment setting) and the marker system 140 is disabled when the treating material delivery system 120 is disabled (e.g., when the treating material control 134 is in the second treatment setting). In other words, the first marker setting and the second marker setting may be a part of the independent marker configuration and the third marker setting may be a part of the dependent marker configuration.

It is noted that the dependent marker configuration or third marker setting of the marker fluid control 150 may be described as the default position. In other words, an operator may maintain the marker fluid control 150 in the default position in which the marker system 140 matches or replicates the treating material delivery system 120. In such position, the operator may not be manipulating two separate controls, but rather only need to focus on one control (e.g., the treating material control 134) to both deliver treating material to the ground surface 103 and provide a visual marker for identifying a lateral treatment path boundary. In other words, the operator may switch the marker fluid control 150 to the independent marker configurations (e.g., the first marker setting or the second marker setting) as needed, but the marker fluid control 150 typically remains and/or initially starts at the dependent marker configuration or third marker setting.

In one or more embodiments, the vehicle 100 may include one single control that enables or disables the treating material delivery system 120 and the marker system 140 at the same time (e.g., simultaneously). In other words, in such embodiments, the treating material delivery system 120 and the marker system 140 may operate in conjunction such that the marker system 140 delivers marking fluid when the treating material delivery system 120 is enabled and the marker system 140 is disabled when the treating material delivery system 120 is disabled. The single control may replace the two controls of the treating material control 134 and the marker fluid control 150. Described another way, in such embodiments, the marker fluid control 150 may be permanently positioned in the dependent marker configuration or third marker setting.

The marker fluid control 150 may include any suitable form and/or structure. For example, as shown in FIG. 4, the marker fluid control 150 may be configured as a three-position switch located on the operator control panel 113 attached to the chassis 102. The marker fluid control 150 also may actuate in any suitable way. For example, the three-position switch of the marker fluid control 150 may include any type of switch such as a rocker switch, a twist mechanism, a linear actuator, a touch panel, a dial switch, a button, etc. As shown in FIG. 4, the three-position switch of the marker fluid control 150 may include an upper/top position defining the first marker setting, a center/middle position defining the second marker setting, and a lower/bottom position defining the third marker setting.

As such, an operator using the treating material control 134 and the marker fluid control 150 of the present disclosure may start the vehicle 100 and initially have the treating material control 134 in the second treatment setting (e.g., the treating material delivery system 120 is disabled) and the marker fluid control 150 in the second marker setting (e.g., the marker system 140 is disabled). Alternatively, the marker fluid control 150 may be in third marker setting (e.g., dependent on the treating material control 134) such that, because the treating material control 134 is in the second treatment setting, the marker system 140 is also disabled.

In anticipation of operating the vehicle 100 to apply treating material to the ground surface 103, the operator may engage or enable the treating material delivery system 120 by moving the treating material control 134 to the first treatment setting. If the marker fluid control 150 is already in the third setting, the marker system 140 may also enable simultaneously with the treating material delivery system 120. Therefore, the operator may control both of the treating material delivery system 120 and the marker system 140 together (e.g., with the marker fluid control 150 in the third marker setting). As the treating material is being applied to the ground surface 103, the marking fluid is also being delivered to the ground surface 103 to identify the boundaries of the treatment path. Therefore, the operator can treat the ground surface 103 in efficient paths (e.g., parallel paths) that do not overlap or leave gaps between the paths.

Once the operator is finished, the treating material control 134 may be moved to the second treatment setting to disable both the treating material delivery system 120 and the marker system 140 (e.g., because the marker fluid control 150 is in the third marker setting). If the operator wants to control the marker system 140 independent from the treating material delivery system 120, the marker fluid control 150 may be moved to either the first marker setting (e.g., marker system 140 enabled) or the second marker setting (e.g., marker system 140 disabled).

Furthermore, in one or more embodiments contemplated herein, the marker fluid control 150 may include a setting in which the marker system may be dependent on the movement and/or propulsion of the vehicle 100. For example, the marker system 140 may be enabled (e.g., to deliver marking fluid to the ground surface 103) when the vehicle 100 is moving and the marker system 140 may be disabled when the vehicle 100 is not moving (e.g., stationary). This configuration may allow the operator to identify or track where the vehicle 100 has traversed and/or may prevent the marker fluid from building up on the ground surface 103 in one location when the vehicle 100 is not moving. This vehicle movement dependent marker setting may be in addition to the marker settings described herein or may replace the third marker setting.

The complete disclosure of the patents, patent documents, and publications cited herein are incorporated by reference in their entirety as if each were individually incorporated. In the event that any inconsistency exists between the disclosure of the present application and the disclosure(s) of any document incorporated herein by reference, the disclosure of the present application shall govern.

Illustrative embodiments are described and reference has been made to possible variations of the same. These and other variations, combinations, and modifications will be apparent to those skilled in the art, and it should be understood that the claims are not limited to the illustrative embodiments set forth herein.

What is claimed is:

1. A ground treatment vehicle comprising:
a chassis supported upon a ground surface by ground engaging members;
a treating reservoir attached to the chassis and configured to hold a ground treating material;
a treating material delivery system configured to deliver the treating material from the treating reservoir to the ground surface;
a marker reservoir for holding a marking fluid;
a marker system configured to deliver the marking fluid from the marker reservoir to the ground surface;
a treating material control configured to control the treating material delivery system, wherein the treating material control comprises: a first treatment setting, wherein the treating material delivery system is enabled so that the treating material is transferred to the ground surface; and a second treatment setting, wherein the treating material delivery system is disabled; and
a marker fluid control configured to control flow of the marker fluid from the marker reservoir to a marker nozzle operatively attached to the chassis, wherein the marker fluid control comprises: a first marker setting, wherein the marker system is enabled to deliver the marking fluid to the ground surface; a second marker setting, wherein the marker system is disabled; and a third marker setting, wherein the marker system is enabled when the treating material control is in the first treatment setting, and disabled when the treating material control is in the second treatment setting.

2. The vehicle of claim 1, wherein the treating material comprises a material selected from the group consisting of liquid and granular materials.

3. The vehicle of claim 1, wherein the marker system comprises a pump and the marking fluid comprises a foaming agent.

4. The vehicle of claim 1, wherein the treating material control is configured as a foot-actuated switch located upon a standing operator platform attached to the chassis.

5. The vehicle of claim 1, wherein the treating material control is configured as a hand-operated switch located on an operator control panel attached to the chassis.

6. The vehicle of claim 1, wherein the marker fluid control is configured as a three-position switch located on an operator control panel attached to the chassis.

7. The vehicle of claim 1, treating material delivery system comprises a pump configured to deliver a liquid treating material from the treating reservoir to the ground surface.

8. The vehicle of claim 1, wherein the treating material delivery system comprises a broadcast spinner configured to deliver a granular treating material from the treating reservoir to the ground surface.

9. The vehicle of claim 1, wherein the marker nozzle comprises:
a first marker nozzle configured to disperse marking fluid at a first lateral position relative to the chassis; and
a second marker nozzle configured to disperse marking fluid at a second lateral position relative to the chassis, wherein the first and second lateral positions define a treating width of the vehicle.

10. A system for controlling a visual marker system configured to identify a lateral treatment path boundary resulting from application of a ground treating material by a ground treatment vehicle, wherein the system comprises:
a treating reservoir attached to a chassis of the vehicle and configured to hold a volume of ground treating material;
a treating material delivery circuit configured to selectively deliver the treating material from the treating reservoir to a ground surface;
a marker reservoir attached to the chassis for holding a volume of marking fluid;
a marker circuit configured to deliver the marking fluid from the marker reservoir to the ground surface;
a treating material control configured to control the treating material delivery circuit, wherein the treating material control comprises: a first treatment setting, wherein the treating material delivery circuit is enabled so that the treating material is transferred to the ground surface; and a second treatment setting, wherein the treating material delivery circuit is disabled; and
a marker fluid control configured to control flow of the marker fluid from the marker reservoir to a marker nozzle operatively attached to the chassis, wherein the marker fluid control comprises: a first marker setting, wherein the marker circuit is enabled to deliver the marking fluid to the ground surface; a second marker setting, wherein the marker circuit is disabled; and a third marker setting, wherein the marker circuit is enabled when the treating material control is in the first treatment setting, and disabled when the treating material control is in the second treatment setting.

11. The system of claim 10, wherein the marker circuit further comprises a pump configured to selectively port the marking fluid to the marker nozzle.

12. The system of claim 10, wherein the treating material comprises a material selected from the group consisting of liquid and granular materials.

13. The system of claim 10, wherein the treating material control is configured as a foot-actuated switch located upon a standing operator platform attached to the chassis.

14. The system of claim 10, wherein the treating material control is configured as a hand-operated switch located on an operator control panel attached to the chassis.

15. The system of claim 10, wherein the marker fluid control is configured as a three-position switch located on an operator control panel attached to the chassis.

16. A system for controlling a visual marker system configured to identify a lateral treatment path boundary resulting from application of a ground treating material by a ground treatment vehicle, wherein the system comprises:
a treating reservoir attached to a chassis of the vehicle and configured to hold a volume of ground treating material;
a treating material delivery circuit configured to selectively deliver the treating material from the treating reservoir to a ground surface;
a marker reservoir attached to the chassis for holding a volume of marking fluid;
a marker circuit configured to deliver the marking fluid from the marker reservoir to the ground surface;
a treating material control configured to control the treating material delivery circuit, wherein the treating material control comprises: a first treatment setting, wherein the treating material delivery circuit is enabled so that the treating material is transferred to the ground surface; and a second treatment setting, wherein the treating material delivery circuit is disabled; and
a marker fluid control configured to control flow of the marker fluid from the marker reservoir to a marker nozzle operatively attached to the chassis, wherein the marker fluid control comprises: an independent marker configuration, wherein the marker circuit is enabled to deliver the marking fluid to the ground surface or disabled from delivering the marking fluid regardless of the treatment setting of the treating material control; and a dependent marker configuration, wherein the marker circuit is enabled when the treating material control is in the first treatment setting and disabled when the treating material control is in the second treatment setting.

17. The system of claim 16, wherein the independent configuration comprises:
an on position, wherein the marker circuit is enabled to deliver the marking fluid regardless of the treatment setting of the treating material control; and
an off position, wherein the marker circuit is disabled regardless of the treatment setting of the treating material control.

18. The system of claim 16, wherein the treating material comprises a material selected from the group consisting of liquid and granular materials.

19. The system of claim 16, wherein the treating material control is configured as a foot-actuated switch located upon a standing operator platform attached to the chassis.

20. The system of claim 16, wherein the treating material control is configured as a hand-operated switch located on an operator control panel attached to the chassis.
